(19) United States
(12) Patent Application Publication
(10) Pub. No.: US 2015/0122026 A1
(43) Pub. Date: May 7, 2015

(54) ULTRASONIC MEASURING METHOD AND DEVICE

(71) Applicant: Panasonic Corporation, Osaka (JP)

(72) Inventors: JUN YOKOYAMA, Osaka (JP); HIDEYUKI TACHIKA, Osaka (JP)

(21) Appl. No.: 14/483,149

(22) Filed: Sep. 10, 2014

(30) Foreign Application Priority Data
Nov. 5, 2013 (JP) 2013-229151

(51) Int. Cl. G01N 29/04; G01N 29/09

(52) U.S. Cl. CPC G01N 29/043; G01N 29/09; G01N 2291/0215; G01N 2291/0289; G01N 2291/0237; G01N 2291/0234; G01N 2291/0421
USPC 73/596

(57) ABSTRACT

An ultrasonic measuring method for measuring an inside of a measured object by using ultrasonic waves propagating through air includes attaching a sheet having an acoustic impedance higher than the air as well as lower than the measured object to the measured object and measuring the inside of the measured object to which the sheet is attached by using a sensor.

### CROSS REFERENCE TO RELATED APPLICATIONS

The present application claims the benefit of foreign priority to Japanese Patent Application No. 2013-229151 filed on Nov. 5, 2013, the contents of which are incorporated herein by reference.

### BACKGROUND

1. Technical Field

The technical field relates to a method and a device for measuring an inside of a measured object by using ultrasonic waves propagating through the air.

2. Description of Related Art

As shown in FIG. 9, there is proposed a method as a related art example, in which an ultrasonic wave 2 oscillated from an ultrasonic sensor 1 for transmission is allowed to be incident on a measured object 3 through the air, and the ultrasonic wave 2 transmitted through the inside of the measured object 3 is received by an ultrasonic sensor 4 for reception through the air to thereby perform internal measurement of the measured object 3 (for example, JP-A-2008-128965 (Patent Document 1).

### SUMMARY

However, the difference of acoustic impedances between the measured object and the air is generally 1000 times or more, therefore, the transmittance of ultrasonic waves is low in the above related art example, which causes problems that a SN ratio (signal to noise ratio) is lowered and measurement accuracy is low.

Accordingly, this disclosure has been made for solving the above problems and a measured object thereof is to provide a highly-accurate ultrasonic measuring method and device by increasing the transmittance of ultrasonic waves.

In order to achieve the above object, this disclosure provides an ultrasonic measuring method for measuring an inside of a measured object by using ultrasonic waves propagating through the air, which includes attaching a sheet having an acoustic impedance higher than the air as well as lower than the measured object to the measured object and measuring the inside of the measured object to which the sheet is attached by using a sensor.

This disclosure also provides an ultrasonic measuring device measuring the inside of a measured object by using ultrasonic waves propagating through the air, which includes a sheet having an acoustic impedance higher than the air as well as lower than the measured object, an attaching mechanism configured to attach the sheet to the measured object and a sensor configured to measure the inside of the measured object to which the sheet is attached.

As described above, according to this disclosure, highly accurate ultrasonic measuring method and device can be realized by performing ultrasonic measurement of the measured object through the sheet.

### BRIEF DESCRIPTION OF THE DRAWINGS

FIG. 1 is a view showing a schematic structure of an ultrasonic measuring method according to Embodiment 1;

FIG. 2 is a graph showing the relation between acoustic impedances of a sheet in Embodiment 1 and a ratio with respect to transmittance in a related art example;

FIG. 3 is a view showing a schematic structure of an ultrasonic measuring device according to Embodiment 1;

FIG. 4 is a flow chart of the ultrasonic measuring method according to Embodiment 1;

FIG. 5 is a view showing a schematic structure of an ultrasonic measuring method according to Embodiment 1;

FIG. 6 is a view showing a schematic structure of an ultrasonic measuring method according to Embodiment 2;

FIGS. 7A and 7B are schematic views showing the difference in propagation of ultrasonic waves between Embodiments 1 and 2;

FIG. 8 is a view showing a schematic structure of an ultrasonic measuring method according to Embodiment 3; and

FIG. 9 is a view showing a related art example.

### DESCRIPTION OF EMBODIMENTS

Hereinafter, embodiments will be explained with reference to the drawings.

### Embodiment 1

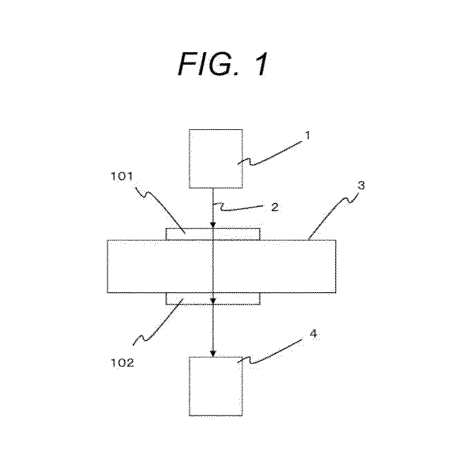

FIG. 1 shows a schematic structure for performing an ultrasonic measuring method according to the embodiment. First, an outline of the ultrasonic measuring method will be explained. An ultrasonic wave 2 oscillated front an ultrasonic sensor 1 for transmission propagates through the air and is incident on a measured object 3 through a sheet 101 attached to a surface of the measured object 3. After that, the ultrasonic wave 2 transmitted through an inside of the measured object 3 is emitted to the air through a sheet 102 attached to a reverse surface of the measured object 3, and is incident on an ultrasonic sensor 4 for reception through the air. Then, a waveform of the ultrasonic wave 2 from the measured object 3 received by the ultrasonic sensor 4 is analyzed to thereby perform inside measurement of the measured object 3.

In FIG. 1, the measured object 3 is configured by, for example, two copper plates each having 1 mm in thickness being bonded by thermal diffusion. Both the ultrasonic sensor 1 for transmission and the ultrasonic sensor 4 for reception are so-called aerial ultrasonic sensors. The aerial ultrasonic sensor is a sensor configured to receive or transmit ultrasonic waves propagating through the air. A center frequency of the ultrasonic sensor 1 for transmission and the ultrasonic sensor 4 for reception as the aerial ultrasonic sensors is, for example, a nominal frequency of 800 kHz. The sheet 101 and the sheet 102 are made of, for example, cis-butadiene rubber. The sheet 1 and the measured object 3 closely contact each other without interposing an air layer, and the sheet 101 is stuck to the measured object 3 by air pressure. The sheet 102 is stuck to the measured object 3 in the same manner as the sheet 101.

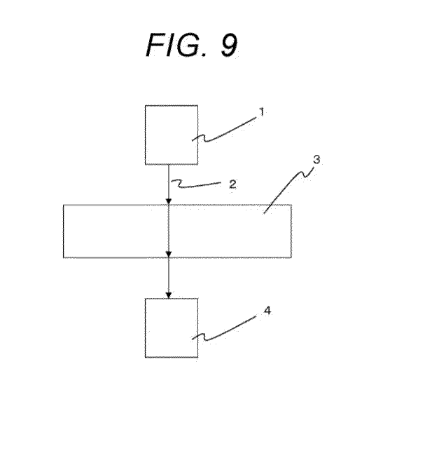

Here, the transmittance of the ultrasonic wave 2 is compared between the embodiment and the related art example. Acoustic impedances of the air, the measured object 3, the sheet 101 and the sheet 102 are respectively set to Z₁, Z₂ and Z₃. In this case, the ultrasonic wave propagates through the air, the measured object 3 and the air in this order in the related art example shown in FIG. 9, therefore, a transmittance T_{conv.} of the ultrasonic wave in the related art example is represented by Equation 1.

T_{conv.}=4·Z₁·Z₂/(Z₁+Z₂)² (Equation 1)

On the other hand, the ultrasonic wave propagates through the air, the sheet 101, the measured object 3, the sheet 102 and the air in this order in the present embodiment shown in FIG. 1. A transmittance Tₑₓₑ₁ in the embodiment is represented by Equation 2.

Tₑₓₑ₁=16·Z₁·Z₂·Z₃²/{(Z₁+Z₃)²·(Z₃+Z₂)²} (Equation 2)

When the measured object 3 is copper and the sheet 101 as well as the sheet 102 are cis-butadiene rubber, respective acoustic impedances are Z₁=408 Ns/m, Z₂=4.49×10⁷ Ns/m and Z₃=1.5×10⁶ Ns/m. In this case, the transmittance T_{conv.} equals to 3.63×10⁻⁵ based on Equation 1. Then, the transmittance Tₑₓₑ₁ in the embodiment shown in FIG. 1 equals to 1.36×10⁻⁴. Accordingly, a ratio of the transmittance Tₑₓₑ₁ in the embodiment with respect to the transmittance T_{conv.} (Tₑₓₑ₁/T_{conv.}) equals to 3.74. Accordingly, the sensitivity of ultrasonic waves to be received (transmittance of ultrasonic waves) is 3.74 times improved by applying the ultrasonic measuring method according to the embodiment.

In this case, it is desirable to set a thickness “t” of the sheet 101 and the sheet 102 to a value defined by Equation 3 in the embodiment. The transmittance of the ultrasonic wave can be improved more by satisfying a condition of Equation 3.

t=Vs/(4×fo) (Equation 3)

Here, “Vs” denotes an acoustic velocity of a longitudinal wave of the sheet 101 and the sheet 102, and “fo” denotes the center frequency of the ultrasonic sensor 1 and the ultrasonic sensor 4. Respective components are set so as to satisfy Equation 3, thereby minimizing reflection at respective interfaces of the sheet 101, the sheet 102, the measured object 3 and the air as well as maximizing the transmittance of the ultrasonic wave 2. As the sheet 101 and the sheet 102 having an acoustic velocity of a longitudinal wave Vs=1590 m/s and the ultrasonic sensors 1 and 4 having the center frequency fo=800 kHz are applied in the embodiment, the thickness of the sheet 101 and the sheet 102 is set to 0.5 mm based on Equation 3.

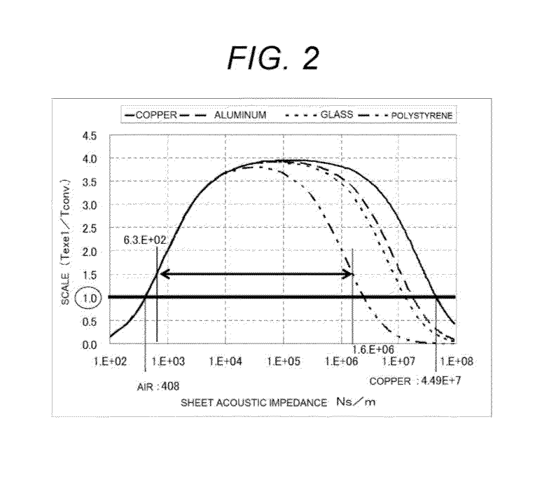

Next, preferable acoustic impedances in the sheet 101 and the sheet 102 will be explained. FIG. 2 is a graph showing the relation between acoustic impedances of sheets in the embodiment when materials of measured objects are copper, aluminum, glass and polystyrene, and the ratio of transmittance of the embodiment with respect to the related art example. In the graph shown in FIG. 2, a horizontal axis represents acoustic impedances of the sheets in a logarithmic scale, and a vertical axis represents the ratio between the transmittance Tₑₓₑ₁ in the embodiment and the transmittance T_{conv.} in the related art example calculated by Equation 1 and Equation 2. Here, acoustic impedances of aluminum, glass and polystyrene are respectively 1.73×10⁷ Nₛ/m, 1.28×10⁷ Nₛ/m and 2.48×10⁶ Nₛ/m. As apparent from the graph, it can be found that a condition in which Tₑₓₑ₁/T_{conv.} is higher than 1, that is, a condition of the acoustic impedance of the sheet in which the transmittance in the embodiment is higher than that of the related art example is that the acoustic impedance is higher than the air as well as lower than the measured object.

Accordingly, materials satisfying a condition in which the acoustic impedance is higher than the air as well as lower than the measured object 3 are applied for the sheet 101 and the sheet 102 of FIG. 1. More preferably, a condition in which the acoustic impedance of the sheet 101 and the sheet 102 is equal to or higher than 6.5×10² Nₛ/m as well as equal to or lower than 1.6×10⁶ Nₛm is satisfied. This is because the transmittance can be more than 1.5 times increased in the embodiment as compared with the related art example when polystyrene which is widely used for industrial products is the measured object as apparent from FIG. 2. The inventors have found, that more accurate measurement can be performed when the transmittance is 1.5 times increased. In materials satisfying the condition of the acoustic impedance, cis-butadiene rubber which is a material easily stuck to the surface of the measured object 3 is selected as a material for the sheet 101 and the sheet 102 in the embodiment.

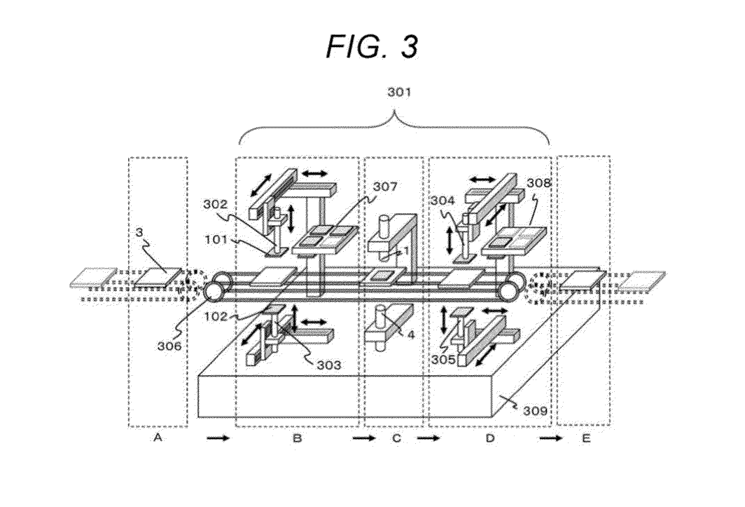

Here, FIG. 3 shows a measuring device 301 as an example of an ultrasonic measuring device according to the embodiment.

The measuring device 301 includes a position “B” where sheet attaching mechanisms 302 and 303 are disposed, a position “C” where ultrasonic sensors 1 and 4 are disposed and a position “D” where sheet detaching mechanisms 304 and 305 are disposed. The measuring device 301 attaches the sheets to obverse and reverse surfaces of the measured object 3 at the same time. The measuring device 301 also detaches the sheets from the obverse and reverse surfaces of the measured object 3 at the same time.

The measured object 3 is conveyed from a position “A” to the position “B” of the measuring device 301 by a conveying means 306, then, sequentially conveyed in the order of the positions “B”, “C” and “D” in the measuring device 301, and finally, conveyed to a position “E” which is the outside of the measuring device 301. As the measured object 3 is sequentially supplied to the position “A”, plural measured objects 3 are fed into the measuring device 301, and work is performed in the positions “B”, “C” and “D” in parallel. The conveying means 306 is, for example, a belt conveyer conveying the measured object 3 by supporting two edges at both ends of the measured object 3 by two belts, which has an opening at the center so that measurement by the ultrasonic sensors 1 and 4 in the position “C” can be performed on the belt conveyor.

The sheet attaching mechanisms 302 and 303 include, for example, a robot which can perform triaxial drive and a suction nozzle. Plural sheets 101 and 102 previously prepared in a sheet supply means 307 are sequentially conveyed to obverse and reverse surfaces of the measured object 3 by the suction nozzle, and the sheets 101 and 102 are pressed onto the obverse and reverse surfaces of the measured object 3 with a pressurizing force of approximately 10N. Accordingly, the sheet attaching mechanisms 302 and 303 configured to attach the sheets 101 and 102 to both surfaces as principal surfaces of the measured object 3. The sheet detaching mechanisms 304 and 305 also include the robot which can perform triaxial drive and the suction nozzle, sucking the sheet 101 and the sheet 102 stuck to both surfaces of the measured object 3 respectively by the suction nozzle to peel off (detach) the sheets. The sheet 101 and the sheet 102 which have been peeled off are conveyed to a sheet collecting means 308. The sheet 101 and the sheet 102 which have been collected by the sheet collecting means 308 are disposed on the sheet supply means 307 and used again. The above sheet attaching mechanisms 302, 303, the sheet detaching mechanisms 304, 305, the ultrasonic sensors 1, 4, the conveying means 306, the sheet supply means 307 and the sheet collecting means 308 are arranged on a frame 309 of the measuring device 301.

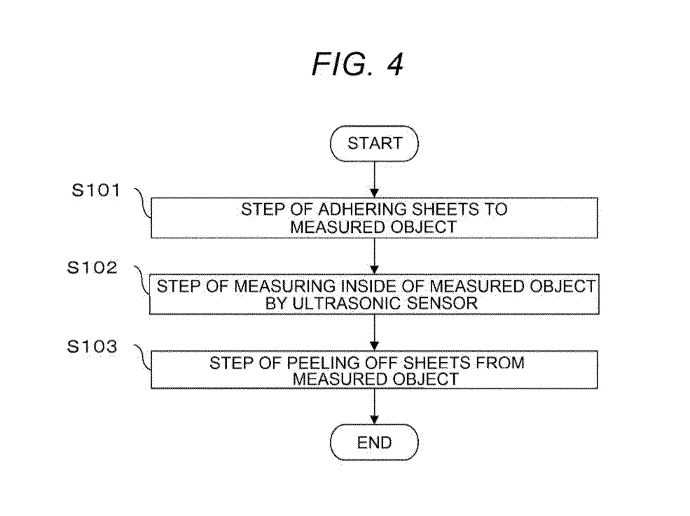

Next, the flow of the ultrasonic measuring method according to the embodiment will be explained in accordance with a flowchart of FIG. 4 based on the structure of FIG. 3. Step S101 of FIG. 4 is a step performed in the position “B” of FIG. 3. In this step, the sheet 101 and the sheet 102 are attached to surfaces of the measured object 3 conveyed from the position “A” by the sheet attaching mechanisms 302 and 303.

Next, Step S102 of FIG. 4 is a step performed in the position “C” of FIG. 3. In this step, the inside of the measured object 3 conveyed to the position “C” after the sheet 101 and the sheet 102 are attached is measured by using the ultrasonic sensors 1 and 4. As the inside of the measured object 3 is measured by using ultrasonic waves through the sheet 101 and the sheet 102, the ultrasonic measurement can be performed with higher sensitivity as compared with the related art example. The schematic view of the ultrasonic measuring method performed in the position “C” is shown FIG. 1.

Lastly, Step S103 of FIG. 4 is a step performed in the position “D” of FIG. 3. In this step, the sheet 101 and the sheet 102 are detached from the measured object 3 conveyed from the position “C” by the sheet detaching mechanisms 304 and 305.

These steps of S101 to S103 can be executed in parallel when plural measured objects 3 are sequentially measured. Accordingly, even when the attaching/detaching steps of the sheets are performed as in the embodiment, the sensitivity of ultrasonic waves which can be received can be improved without extending the measurement time per one measured object as compared with the related art example.

Although the sheet 101 and the sheet 102 of FIG. 3 are stuck to the measured object 3 by air pressure in the embodiment, the sheet 101 and the sheet 102 may be stuck to the measured object 3 through an adhesive material previously applied to the sheet 101 and the sheet 102. In this case, the adhesive material has preferably an acoustic impedance higher than the sheet 101 and the sheet 102 as well as lower than the measured object 3. It is further preferable that the adhesive material is as thin as possible so as not to hinder the transmission of ultrasonic waves. Accordingly, a thickness of the adhesive material is preferably, for example, several 10 μm or less.

In the present embodiment, other mechanism can be applied in addition to the sheet attaching mechanisms 302, 303 and the sheet detaching mechanisms 304, 305. For example, it is preferable to apply a mechanism as the sheet attaching mechanism 302 and 303, in which the sheet 101 and the sheet 102 are arranged at ends of a mechanism which holds the measured object 3 by sandwiching the measured object 3, holding the measured object 3 and allowing the sheet 101 and the sheet 102 to closely contact measured surfaces of the measured object 3 in the position “B”. In this case, the sheet detaching mechanisms 304 and 305 may nave a structure in which the holding of the measured object 3 is released as well as the sheet 101 and the sheet 102 are detached from the measured object 3 in the position “D”. Such mechanism is preferable when a turn-table system is applied as the conveying means.

Although the sheet 101 and the sheet 102 are attached to both surfaces of the measured object 3 in the embodiment, it is also preferable that the sheet is attached only to one side of the measured object 3. For example, when only the sheet 102 is provided without the sheet 101, the ultrasonic wave 2 propagates through a path of the air, the measured object 3, the sheet 102 and the air in this order, and a transmittance Tₑₓₑ₂ in this case is represented by Equation 4.

Tₑₓₑ₂=8·Z₁·Z₂·Z₃/{(Z₁+Z₂)·(Z₂+Z₃)·(Z₃·Z₁)} (Equation 4)

The transmittance Tₑₓₑ₂ is 7.03×10⁻⁵ from Equation 4 in this case, and a ratio with respect to the transmittance T_{conv.} in the related art example (Tₑₓₑ₂/T_{conv.}) is 1.93. That is, the transmittance of ultrasonic waves is improved 1.93 times also when the sheet is attached only to one side. In this case, it is more effective that the sheet 102 is attached only to the surface facing the ultrasonic sensor 4 for reception in principal surfaces of the measured object 3. The sheet 102 is set to a size necessary for measurement, thereby relatively reducing effects of ultrasonic waves 2 propagating through paths not necessary for measurement and improving the S/N ratio. More specifically, the ultrasonic wave 2 is scattered inside and is emitted from the measured object 3 to the air also including reflection waves (noise) in portions which are not measured. The effects of noise can be alleviated by the sheet 102. In the case where the sheet 101 is not provided, for example, a pulse laser which directly introduces ultrasonic waves to the surface of the measured object 3 can be used instead of using the ultrasonic sensor for transmission 1.

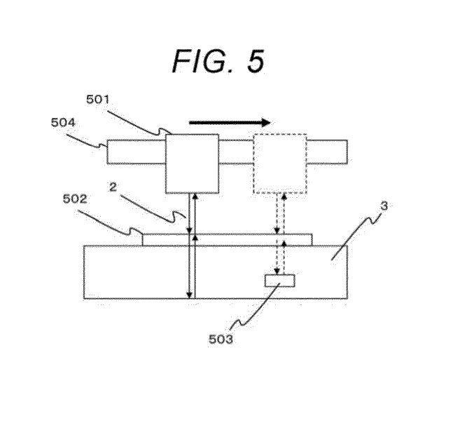

The internal measurement is realized by using the ultrasonic wave 2 which has been transmitted through the measured object 3 in FIG. 1 and. FIG. 3. On the other hand, it is also preferable to perform internal measurement by using the ultrasonic wave 2 reflected on a bottom surface of the measured object 3 as shown in FIG. 5. The ultrasonic wave 2 oscillated from an ultrasonic sensor 501 for transmission/reception of FIG. 5 propagates through the air, and is incident on the measured object 3 through a sheet 502 attached to the measured object 3. The sheet 502 is attached to the surface of the measured object 3. The ultrasonic wave 2 propagating through the inside of the measured object 3 reflects on the bottom surface (reverse surface) or a gap defect 503 of the measured object 3 and is emitted to the air through the sheet 502 to be received by the ultrasonic sensor 501 for transmission/reception. The ultrasonic sensor 501 for transmission/reception is mounted on an XY stage 504 for two-dimensionally scanning the surface of the measured object 3, which measures, for example, the gap defect 503 inside the measured object 3 by analyzing a waveform of the ultrasonic wave 2 from the measured object 3 received in respective measuring positions.

As it is necessary to separate the ultrasonic wave 2 reflected on the surface of the measured object 3 and the ultrasonic wave reflected on the gap defect 503 inside the measured object 3 in the case of the structure shown in FIG. 5, the center frequency of the ultrasonic sensor 501 for transmission/reception is preferably higher. It is preferable to select the ultrasonic sensor 501 having the center frequency of 1 MHz or more to 3 MHz or less. It is because, acoustic velocities of materials used in general industrial products are in a range of 2000 m/s to 6000 m/s, and frequencies of 1 MHz or more are suitable for measuring a defect existing in a depth of several millimeters inside the measured object 3. A damping ratio in the air is drastically increased when the frequency is 3 MHz or more and it is difficult to detect the ultrasonic wave 2 with sufficient intensity. In the structure of FIG. 5, the ultrasonic sensor 501 with a nominal frequency of 2 MHz as the center frequency is selected. Moreover, cis-butadiene rubber is used for the sheet 502 and the thickness is set to 0.2 mm based on Equation 3.

The structure of FIG. 5 is applied in the position “C” of FIG. 3.

As described above, the sensitivity of ultrasonic waves can be improved also in the ultrasonic measuring method by a pulse reflection method which performs measurement only from one side surface of the measured object 3 by using the ultrasonic sensor 501 for transmission/reception.

In the ultrasonic measuring method by the transmission method as shown in FIG. 1 and FIG. 3, it is not necessary to increase the center frequency of the ultrasonic wave 2 as there is no information in the depth direction of the inside of the measured object 3, therefore, it is preferable to select the ultrasonic sensors 1 and 4 with the center frequency of 100 kHz or more to 1 MHz or less in terms of efficiency of receiving the ultrasonic wave 2. Accordingly, the ultrasonic sensor with a nominal frequency of 800 kHz as the center frequency is used in the structure of FIG. 1 and FIG. 3.

When the sheet 101 and the sheet 102 do not affect the measured object 3, it is not always necessary to perform the process of Step S103. In this case, it is not always necessary that the measuring device 301 of FIG. 3 as an example of the ultrasonic measuring device in the embodiment includes the sheet detaching mechanisms 304 and 305. However, it is desirable to detach the sheet 101 and the sheet 102 from the measured object 3 in consideration of the influence to the measured object 3 and recycling property.

### Embodiment 2

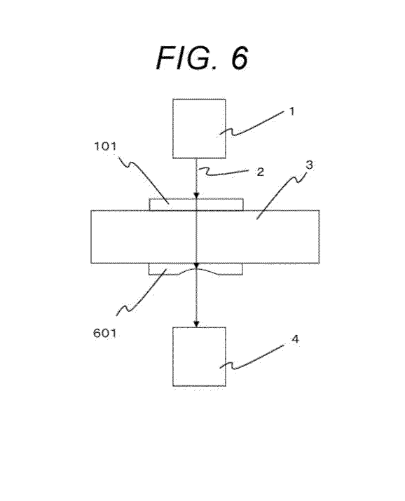

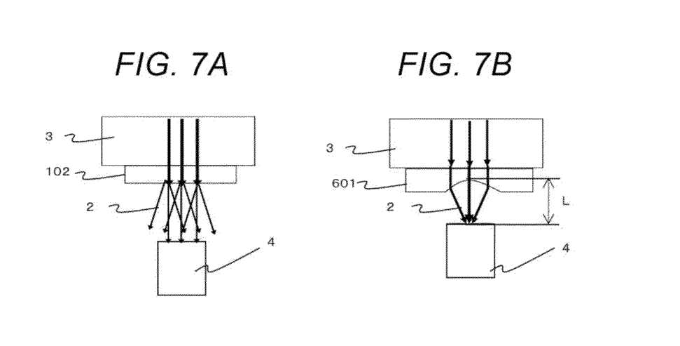

FIG. 6 shows a schematic structure of an ultrasonic measuring method according to Embodiment 2. The present embodiment differs from Embodiment 1 in a point that a concave portion formed by a curved surface is provided on a surface of a sheet 601 attached to the side facing the ultrasonic sensor 4 for reception of the measured object 3. FIGS. 7A and 7B schematically show a state in which the ultrasonic waves 2 propagate in the air from the measured object 3 through the sheet. FIG. 7A is a schematic view showing propagation of the ultrasonic waves according to Embodiment 1 and FIG. 7B is a schematic view showing propagation of ultrasonic waves according to Embodiment 2. As shown in FIG. 7A, when the surface of the sheet 102 is a flat surface, the ultrasonic waves 2 emitted from the sheet 102 spread radially. When the distance between the sheet 102 and the ultrasonic sensor 4 for reception becomes far by the limitation of measurement conditions, spreading of the ultrasonic waves 2 becomes larger than a reception surface of the ultrasonic sensor 4 for reception and efficiency is reduced. On the other hand, in the case where the concave portion with the curved surface is provided on the surface of the sheet 601 as shown in FIG. 7B, the ultrasonic waves 2 emitted from the sheet 601 are collected toward the reception surface of the ultrasonic sensor 4 for reception, therefore, the ultrasonic waves 2 can be received efficiently.

Here, when the distance between the sheet 601 and the ultrasonic sensor 4 for reception is “L”, the shape of the concave portion on the surface of the sheet 601 is preferably a curved shape with a curvature of a radius “L”. That is, it is preferable that the ultrasonic sensor 4 is disposed in the center of the curvature in the concave portion having the curved surface provided on the surface of the sheet 601. The structure of FIG. 6 is applied in the position “C” of FIG. 3.

As described above, the sensitivity of ultrasonic waves to be received can be improved more according to the embodiment.

### Embodiment 3

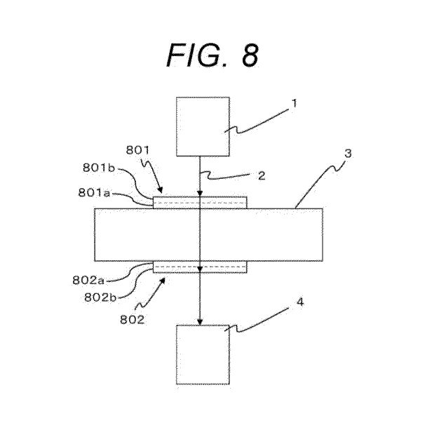

FIG. 8 shows a schematic structure of an ultrasonic measuring method according to Embodiment 3. The present embodiment differs from Embodiment 1 in a point that a sheet 801 and a sheet 802 have a multilayer structure. Here, both the sheet 801 and the sheet 802 have a two-layer structure. A layer positioned in the measured object 3 side of the sheet 801 is a first layer 801a and a layer facing the air is a second layer 801b. A layer positioned in the measured object 3 side of the sheet 802 is a first layer 802a and a layer facing the air is a second layer 802b. In this case, it is necessary to set acoustic impedances of respective components so as to satisfy the relation of the air<the second layer 801b (802b)<first layer 801a (802a)<measured object 3. The reason why the acoustic impedances of respective structures are set as described above will be explained below.

When the acoustic impedances of the air, the measured object 3, the first layer 801a (802a) and the second layer 801b (802b) are respectively set to Z₁, Z₂, Z₃ and Z₄, a transmittance Tₑₓₑ₄ of the ultrasonic wave transmitting through the air, the second layer 801b, the first layer 801a, the measured object 3 and the first layer 802a, the second layer 802b and the air in this order can be represented by Equation 5.

Tₑₓₑ₄=64·Z₁·Z₂·Z₃²·Z₄²/{(Z₁+Z₄)²·(Z₃+Z₄)²·(Z₂+Z₃)²} (Equation 5)

The acoustic impedances of respective components are set based on Equation 5 as described above, the transmittance of the ultrasonic wave 2 can be improved. Specifically, when the acoustic impedances of the first layer 801a (802a) and the second layer 801b (802b) are respectively set to 1.5×10⁶ Ns/m and 9×10⁵ Ns/m, the transmittance Tₑₓₑ₄ is 2.13×10⁻⁴ based on Equation 5, and a ratio of the transmittance Tₑₓₑ₄ of the present embodiment with respect to the transmittance T_{conv.} in the related art example (Tₑₓₑ₄/T_{conv.}) is 5.85. Consequently, according to the embodiment, approximately 5.85 times improvement of transmittance can be expected as compared with the related art example, and the sensitivity of ultrasonic waves to be received can be improved more.

In the present embodiment, cis-butadiene rubber is applied for the first layers 801a and 802a. A resin obtained by mixing plural hollow glasses having approximately 10 μm in diameter to reduce the density and thereby lower an apparent acoustic impedance is used for the second layers 801b and 802b. The flexible rubber material is used for the first layers 801a and 802a which contact the measured object 3, thereby increasing adhesion with respect to the measured object 3 and securing work efficiency. Additionally, the layer closer to the acoustic impedance of the air is applied for the second layers 801b and 802b, the transmittance of the ultrasonic wave 2 can be improved more.

It is possible to realize highly accurate measurement by allowing the sheet 801 to include the first layer 801a and the second layer 801b having a lower acoustic impedance than the first layer 801a as described above. The highly accurate measurement can be also realized by allowing the sheet 802 to include the first layer 802a and the second layer 802b having a lower acoustic impedance than the first layer 802a.

It is desirable to set a thickness “t” of the sheets 801 and 802 to be a value defined by Equation 3. The transmittance of ultrasonic waves can be improved more by satisfying the condition of Equation 3.

Among the above-mentioned various embodiments and modified examples, arbitrary embodiments or modified examples can be appropriately selected and combined to achieve their respective effects. For example, the concave portion having the curved surface applied in Embodiment 2 may be applied to the second layer 802b in FIG. 8. Accordingly, the ultrasonic measuring method with higher accuracy can be realized.

The embodiments can be also applied to applications such as ultrasonic inspection with respect to the inside of electronic devices and structures such as vehicle bodies.

What is claimed is:

1. An ultrasonic measuring method for measuring an inside of a measured object by using ultrasonic waves propagating through air comprising:
attaching a sheet having an acoustic impedance higher than the air as well as lower than the measured object to the measured object; and
measuring the inside of the measured object to which the sheet is attached by using a sensor.

2. The ultrasonic measuring method according to claim 1, further comprising:
detaching the sheet from the measured object after measuring the inside of the measured object.

3. The ultrasonic measuring method according to claim 1,
wherein, when an acoustic velocity of a longitudinal wave of the sheet is “Vs”, a center frequency of the sensor is “fo”, and a thickness of the sheet is “t”, t=Vs/(4×fo) is satisfied.

4. The ultrasonic measuring method according to claim 1,
wherein the sheet includes a concave portion having a curved surface, and
the sensor is arranged in a center of a curvature of the curved surface and receives ultrasonic waves in a center of a curvature of the curved surface.

5. The ultrasonic measuring method according to claim 1,
wherein the sheet includes a first layer and a second layer having a lower acoustic impedance than the first layer, and
the sheet is attached so that the first layer is in the measured object side and the second layer faces the air.

6. An ultrasonic measuring device measuring an inside of a measured object by using ultrasonic waves propagating through air comprising:
a sheet having an acoustic impedance higher than the air as well as lower than the measured object;
an attaching mechanism configured to attach the sheet to the measured object; and
a sensor configured to measure the inside of the measured object to which the sheet is attached.

7. The ultrasonic measuring device according to claim 6, further comprising:
a detaching mechanism configured to detach the sheet from the measured object.

8. The ultrasonic measuring device according to claim 6,
wherein, when an acoustic velocity of a longitudinal wave of the sheet is “Vs”, a center frequency of the sensor is “fo”, and a thickness of the sheet is “t”, t=Vs/(4×fo) is satisfied.

9. The ultrasonic measuring device according to claim 6,
wherein the sheet includes a concave portion having a curved surface, and
the sensor receives ultrasonic waves in a center of a curvature of the curved surface.

10. The ultrasonic measuring device according to claim 6,
wherein the sheet includes a first layer and a second layer having a lower acoustic impedance than the first layer, and
the sheet is attached by the attaching mechanism so that the first layer is in the measured object side and the second layer faces the air.

11. A method of measuring an inside of an object comprising:
generating one or more ultrasonic waves which are propagated toward a sensor via the object and air;
receiving the one or more ultrasonic waves at the sensor; and
measuring the inside of the object by analyzing the received one or more ultrasonic waves,
wherein a sheet having an acoustic impedance higher than the air as well as lower than the object is attached to a surface of the object.
